(19) United States
(12) Patent Application Publication
(10) Pub. No.: US 2025/0162305 A1
(43) Pub. Date: May 22, 2025

(54) PRINTING UNIT AND METHOD FOR ADJUSTING A PRINTING UNIT

(71) Applicant: Kolbus GmbH & Co. KG, Rahden (DE)

(72) Inventors: Waldemar Eirich, Espelkamp (DE); Christian Schmale, Rahden, Pr. Ströhen (DE)

(21) Appl. No.: 18/839,611

(22) PCT Filed: Jan. 9, 2023
(86) PCT No.: PCT/EP2023/050321

§ 371 Date: Aug. 19, 2024

(30) Foreign Application Priority Data
Feb. 18, 2022 (DE) 10 2022 103 869.6

(51) Int. Cl. B41F 31/36; B41F 5/24

(52) U.S. Cl. CPC B41F 31/36; B41F 5/24

(57) ABSTRACT

The invention relates to a printing unit of a printing press or a rotary die cutter for printing sheets and/or webs with an anilox roller transferring ink to the printing cylinder, wherein the anilox roller is assigned an adjustment device, which changes the axis-center distance to the printing cylinder and has two actuators working intermittently against one another.

### BACKGROUND

The present invention relates to printing units according to the preamble of claim 1 and to a method for adjusting a printing unit according to the preamble of claim 8.

Printing units with an anilox roller are known for printing webs or sheets of printing substrates, particularly corrugated board. The anilox roller serves for wetting the printing cylinder with a predefined quantity of printing ink. The anilox roller is moved into an idle position or maintenance position during production breaks and, in particular, during set-up processes. In this case, the distance of the anilox roller to the printing cylinder is sufficiently large for allowing, for example, an exchange of the printing plate.

In known flexographic printing units, e.g. of the firm Hycorr, the anilox roller is received in a pivoting frame in order to realize the change between an operating position and a maintenance position of the anilox roller. This pivoting frame respectively rests on a pneumatic bellows to both sides of the anilox roller with its side lying opposite of the pivot bearings.

In the operating position, the bellows are acted upon with compressed air and raise the pivoting frame against a mechanical stop. The stop is realized in the form of a cam in order to adjust the contact between the anilox roller and the printing cylinder. In the maintenance position, the bellows is ventilated such that the anilox roller is lowered.

Pivoting devices of this type are robust and have a proven track record in the permanent operation of such printing units. However, one disadvantage can be seen in the time required for a change between the production position and the maintenance position of the anilox roller. If individual sheets are missing, e.g. due to separation errors, the mere ventilation of the bellows is not sufficiently fast for adequately lowering the anilox roller in such a way that an ink transfer to the printing roller is prevented in the product gap and a timely ink application for the next sheet is ensured.

### SUMMARY

The invention therefore is based on the objective of making available a printing unit of the initially describe type, as well as a method for the operation thereof, which eliminates at least one of the described disadvantages and makes no high demands regarding the technical design and the costs.

According to the invention, this objective is attained by means of an apparatus with the features of claim 1 and by means of a method with the features of claim 8. Advantageous enhancements of the invention are characterized by the features disclosed in the dependent claims.

The anilox roller accordingly is received in a first adjustment device that is suitable for changing the axis-center distance between the anilox roller and the associated printing cylinder. In order to prevent damages, the axis-center distance is limited to a predetermined minimal dimension by means of a stop. The stop furthermore allows a very high repeat accuracy in the adjustment of the anilox roller to the predetermined minimal distance.

According to the invention, a second adjustment device acts upon the stop in such a way that the minimal axis-center distance attainable by the first adjustment device can be changed by means of the second adjustment device.

In an advantageous embodiment, the first adjustment device comprises at least one pivoting arm, in which the anilox roller is received. It is particularly advantageous to provide two parallel pivoting arms that lie opposite of one another and to mount both sides of the anilox roller in said pivoting arms. The second adjustment device is arranged between the arm and the associated stop in such a way that the first adjustment device and the second adjustment device can act against one another.

The first adjustment device advantageously comprises a first adjustment drive in the form of a pneumatic bellows and the second adjustment device comprises a second adjustment drive in the form of a double-acting pneumatic lifting cylinder. The bellows is suitable for damping vibrations of the anilox roller relative to the printing cylinder. The lifting cylinder is designed for exerting a greater force than the bellows such that, depending on the switching state, the lifting cylinder can remove the anilox roller from the printing cylinder against the force of the bellows. This makes it possible to reach a predefined intermediate position of the anilox roller, in which an ink transfer to the printing cylinder is prevented without having to assume the relatively far maintenance position.

The lifting cylinder is equipped with quick-action ventilating valves in order to achieve a faster change from the operating position into this intermediate position. In addition, the bellows can be at least briefly switched into a depressurized state during this position change in order to reach the intermediate position even faster.

### BRIEF DESCRIPTION OF THE DRAWINGS

An exemplary embodiment of the invention is described below with reference to the figures, to which we refer with respect to all details that are not described in greater detail in the description. In these figures:

FIG. 1 shows a simplified view of an anilox roller with adjustment device in a printing unit;

FIG. 2 shows schematic representations of the adjustment device in three states; and

FIG. 3 shows switching states of the actuators during a change of the anilox roller from the operating position into the intermediate position.

### DETAILED DESCRIPTION

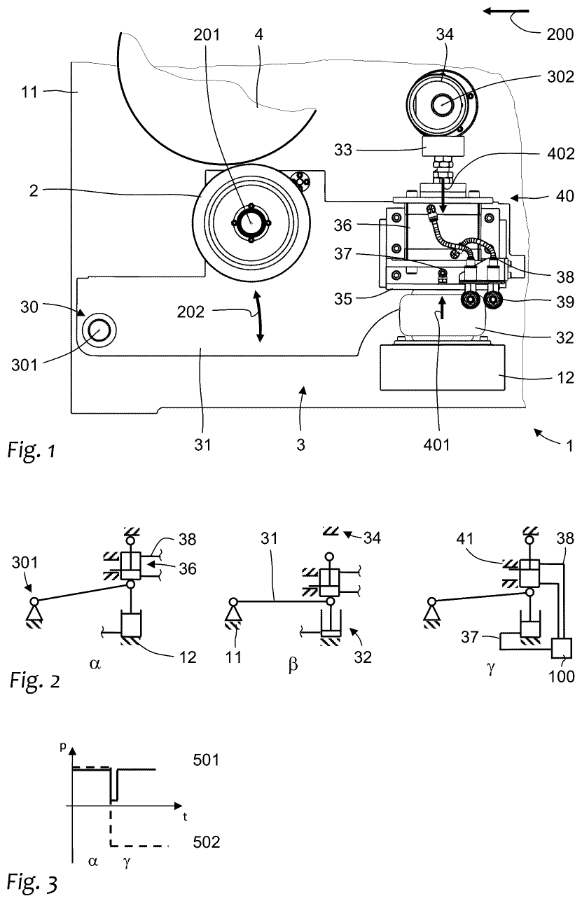

In a machine frame 1 illustrated in FIG. 1, a printing cylinder 4 is mounted in the sidewalls 11 of the machine frame 1, which are arranged to both sides of a transport path 200. The printing cylinder 4 is rotatable about its axis and driven by means of a not-shown drive of conventional design. The printing cylinder 4 is arranged transversally in such a way that it is tangent to the plane defined by the printing substrate.

In addition, an anilox roller 2 is received in the machine frame 1. This anilox roller cooperates with the printing cylinder 4 during the printing process and transfers the printing medium to the printing cylinder 4 in predefined quantity and distribution. To this end, the anilox roller 2 is arranged parallel to the printing cylinder 4.

The anilox roller 2 is received in the machine frame such that its distance to the printing cylinder 4 can be changed. A first adjustment device 3 is provided to this end. This adjustment device comprises two units that are constructed symmetrically to one another and respectively arranged on one of the frame walls 11. One of these two units is described exemplarily below:

A pivoting arm 31 is arranged parallel to the frame wall 11. This pivoting arm is received in the sidewall 11 by means of a pivot bearing 30 of conventional design. The thusly defined pivoting axis 301 of the arm 31 extends parallel to the anilox roller 2. The arm 31 therefore pivots parallel to the sagittal plane of the printing unit. The anilox roller 2 is mounted in the pivoting arm 31 so as to be rotatable about its axis 201.

The pivoting arm 31 essentially is arranged horizontally. It is supported against a crossbeam 12 of the machine frame 1 on its end lying opposite of the pivot bearing 30.

An actuator in the form of a bellows 32 is arranged between the crossbeam 12 and the pivoting arm 31. This bellows is seated on the crossbeam 12 and rigidly connected to the pivoting arm 31 by means of a bracket 35. The bellows 32 is supplied with compressed air via a line 37. It is suitable for damping oscillations or vibrations of the anilox roller. The compressed air line 37 comprises a not-shown controllable valve of conventional design. In this way, the bellows 32 respectively can raise the arm 31 from a lowered idle or maintenance position β into an operating position α or lower the arm into the idle or maintenance position β by means of an oppositely directed pivoting movement 202.

In order to prevent damages to the anilox roller 2 or the printing cylinder 4, the pivoting movement 202 of the arm 31 and therefore the pivoting movement of the anilox roller 2 are mechanically limited. A stop 33 of the pivoting arm 31 is provided to this end. In the pivoted position α, γ, the stop 33 is supported against a counter bearing that is rigidly fixed on the frame as illustrated in FIG. 2. A cam 34 is used as counter bearing.

The cam 34 is mounted in the sidewall 11 so as to be rotatable about a rotational axis 302. It can be fixed in its rotational position with the aid of not-shown means. The cam 34 allows very precise positioning of the anilox roller 2 relative to the printing cylinder 4 in its operating position α. In the exemplary embodiment illustrated in FIG. 1, the rotational axis 302 of the cam 34 is oriented parallel to the rotational axis 201 of the anilox roller 2.

In the idle or maintenance position β, the anilox roller 2 is pivoted away from the printing cylinder 4 by such a distance that it is easily accessible for maintenance procedures and set-up processes. However, it is not necessary and sometimes undesirable to remove the anilox roller 2 from the printing cylinder 4 by such a great distance during brief production breaks or gaps in the product flow. On the other hand, further ink application by the anilox roller should be stopped. This is the reason why an intermediate position γ is provided. In this intermediate position γ, the distance between the printing cylinder 4 and the anilox roller 2 is sufficiently large for preventing the ink transfer from the anilox roller 2 to the printing cylinder 4.

A second adjustment device 40 is provided in order to assume this intermediate position γ. The actuating drive of this second adjustment device is formed by the lifting cylinder 36 illustrated in FIG. 1. The lifting cylinder 36 is arranged between the pivoting arm 31 and the stop 33 of the first adjustment device 3. It is attached to the bracket 35 with its housing. The stop 33 is fastened on the cylinder rod. The pivoting arm 31 therefore is, in a manner of speaking, clamped between the bellows 32 of the first adjustment device 3 and the lifting cylinder 36 of the second adjustment device 40.

The lifting cylinder 36 is supplied with compressed air via the lines 38. One quick-action ventilating valve 39 per cylinder chamber is provided in the compressed air supply 38. The quick-action ventilating valves 39 allow a fast movement 202 and shorten the reaction time. In addition, not-shown switchable valves of conventional design are provided in the compressed air lines 38. In order to achieve a higher degree of automation of the printing unit, the valves in the compressed air lines 37, 38 of the bellows 32 and the lifting cylinder 36 are connected to an electronic control 100 of the printing unit.

The arrangement of the two actuators 32, 36 of the adjustment devices 3, 40 makes it possible for the bellows 32 and the lifting cylinder 36 to selectively work in the same direction or in opposite directions referred to the pivoting movement 202 of the arm 31 and the anilox roller 2. The working directions are controlled by means of the switching state of the not-shown controllable valves in the compressed air supplies 37, 38.

The pneumatic actuators 32, 36 are dimensioned in such a way that the lifting cylinder 36 exerts a greater force than the bellows 32. The lifting cylinder 36 therefore overrides the bellows 32 when the working directions extend opposite to one another. As a result, the force 402 of the lifting cylinder 36 pivots the pivoting arm 31 into the intermediate position γ against the force 401 of the bellows 32. This intermediate position γ is defined by the corresponding limit stop 41 of the lifting cylinder 36. The limit stop 41 is stationary in relation to the pivoting arm 31. It pivots together with the arm 31. The limit stop 41 is simply formed by the internal stop of the lifting cylinder 36.

FIG. 3 shows the first switching state 501 of the bellows 32 and the second switching state 502 of the lifting cylinder 36 during a change from the operating position α into the intermediate position γ. In this case, the second switching state 502 reverses the working direction of the lifting cylinder 36. The bellows 32 is at the same time briefly switched into a depressurized state or ventilated. This makes it possible to additionally reduce the duration of the position change.

### REFERENCE SYMBOLS

1 Machine frame
2 Anilox roller
3 First adjustment device
4 Printing cylinder
11 Wall
12 Crossbeam
30 Pivot bearing
31 Arm
32 Bellows
33 Stop
34 Cam
35 Bracket
36 Lifting cylinder
37 Compressed air line, bellows
38 Compressed air line, lifting cylinder
39 Quick-action ventilating valve
40 Second adjustment device
41 Limit stop
100 Control
200 Transport path
201 Rotational axis of anilox roller
202 Adjusting direction
301 Rotational axis, arm
302 Rotational axis, cam
401 Actuating force, bellows
402 Actuating force, lifting cylinder
501 Switching state, bellows
502 Switching state, lifting cylinder
α Operating position
β Maintenance position
γ Intermediate position

1. A printing unit of a printing press or a rotary die cutter for printing sheets and/or webs of printing substrates, comprising at least
a machine frame (1) with at least two frame walls (11), which are arranged opposite of one another to both sides of the product flow (200), and with at least one crossbeam (12), which transversely connects the at least two frame walls (11),
a printing cylinder (4) that is arranged in the machine frame (1), oriented in a transverse direction and has a first rotational axis, wherein the printing cylinder (4) is designed for transferring printing medium to the printing substrate,
an anilox roller (2) oriented in the transverse direction and has a second rotational axis (201), wherein said anilox roller is arranged in the machine frame (1) in such a way that the anilox roller (2) and the printing cylinder (4) roll on one another in at least one operating state,
a first adjustment device (3) that is connected to the anilox roller (2) and has at least a first adjustment drive and an adjustable path delimiter, wherein a distance of the second rotational axis (201) of the anilox roller (2) to the first rotational axis of the printing cylinder (4) can be changed by means of the at least one first adjustment drive, and wherein a minimum distance of the second rotational axis (201) to the first rotational axis is predetermined by the adjustable path delimiter, and
an electronic control (100), wherein the at least one first adjustment drive is connected to the at least one electronic control (100) in a controllable manner,
wherein said printing unit comprises at least one second adjustment device (40) that is connected to the adjustable path delimiter and adjusts the adjustable path delimiter with respect to its position relative to the anilox roller (2), wherein the at least one second adjustment device (40) has at least one second adjustment drive.

2. The printing unit of claim 1, wherein the at least one first adjustment device (3) has a first adjustment drive in the form of at least one bellows (32) that can be acted upon with a fluid.

3. The printing unit of claim 1, wherein the at least one second adjustment device (40) has a second adjustment drive in the form of at least one lifting cylinder (36) that can be acted upon with a fluid.

4. The printing unit of claim 3, comprising at least one quick-action ventilating valve (39) that is connected to the at least one lifting cylinder (36) by means of a pressure line (38).

5. The printing unit of claim 1, wherein the first adjustment drive is suitable for exerting a first actuating force (401) in an adjusting direction (202), and in that the second adjustment drive is suitable for exerting a second actuating force (402) in the same adjusting direction (202), wherein the second actuating force (402) of the second adjustment drive is at least intermittently greater than the first actuating force (401) of the first adjustment drive such that the second adjustment drive is suitable for overriding the first adjustment drive.

6. The printing unit of claim 1, wherein the at least one first adjustment device (3) has at least one arm (31), which is arranged on the at least one machine frame (1) so as to be pivotable about a third rotational axis (301), and at least one stop (33), which is arranged on the at least one arm (31) and can be pivoted together with the at least one arm (31), wherein
the at least one anilox roller (2) is received in the at least one arm (31) so as to be rotatable about the second rotational axis (201),
the at least one first adjustment drive supports the at least one arm (31) against the machine frame (1) in such a way that the at least one first adjustment drive defines a pivoting position of the at least one arm (31) relative to the machine frame (1),
the at least one stop (33) forms the at least one path delimiter and is arranged so as to be movable relative to the at least one arm (31), and
the at least one second adjustment device defines a position of the at least one stop (33) relative to the at least one arm (31).

7. The printing unit of claim 6, comprising at least one cam (34) that is arranged in the at least one machine frame (1), wherein the at least one cam (34) is arranged so as to be rotatable relative to the machine frame (1) about a fourth rotational axis (302) and forms the at least one path delimiter together with the at least one stop (33) of the first adjustment device (3).

8. A method for positioning an anilox roller (2) relative to a printing cylinder (4) by means of at least one first adjustment device (3) with a first adjusting movement (202), wherein the anilox roller (2) assumes a first end position in the form of a predetermined operating position (α) along the first adjusting movement (202) or a second end position of the adjusting movement (202) in the form of a predetermined maintenance position (β), which deviates from the operating position (α), said method comprising arranging at least one predetermined intermediate position (γ) of the anilox roller (2), along a second adjusting movement, wherein the anilox roller (2) assumes the at least one predetermined intermediate position (γ) by means of a second adjustment device (40).

9. The method of claim 8, wherein the second adjusting movement of the second adjustment device is identical to at least a section of the first adjusting movement (202) of the first adjustment device (3), and in that the at least one intermediate position (γ) of the anilox roller (2) is located on the path of movement of the anilox roller (2) described by the first adjusting movement (202).

10. The method of claim 8, wherein during the change from the operating position (α) into the intermediate position (γ), a first switching state (501) of the first adjustment drive of the first adjustment device (3) at least briefly renders the first adjustment drive powerless whereas a second switching state (502) of the second adjustment drive of the second adjustment device (40) moves the second adjustment device (40) from the first end position into the second end position.
